(19) United States
(12) Patent Application Publication
(10) Pub. No.: US 2024/0102816 A1
(43) Pub. Date: Mar. 28, 2024

(54) Customizing Instructions During a Navigations Session

(71) Applicant: Google LLC, Mountain View, CA (US)

(72) Inventor: Matthew Sharifi, Kilchberg (CH)

(21) Appl. No.: 18/010,714

(22) PCT Filed: Mar. 31, 2022
(86) PCT No.: PCT/US2022/022806

§ 371 Date: Dec. 15, 2022

(51) Int. Cl. G01C 21/34; G01C 21/36; G10L 15/16; G10L 15/26

(52) U.S. Cl. CPC G01C 21/3484; G01C 21/3608; G01C 21/3641; G01C 21/3655; G01C 21/367; G10L 15/16; G10L 15/26

(57) ABSTRACT

Methods and systems for customizing the presentation of navigation instructions to a user during a navigation session are disclosed herein. During a navigation session, a user can request to customize instructions being provided for the navigation session, such as increasing or decreasing a level of detail being provided to the user. Based on the request, the system can determine one or modifications for instructions remaining in the navigation session, modify those instructions, and store the modified instructions for presentation to the user.

### FIELD

The present disclosure relates generally to geographic information systems or other mapping applications. In particular, the present disclosure is directed to systems and methods for customizing the presentation of navigation instructions to a user during a navigation session.

### BACKGROUND

A computing device such as a smartphone, a laptop computer, or an onboard vehicle computer can operate a browser, mapping application, or a geographic information system to provide maps and/or other geographic information and data to a user. For example, a user can search a map for one or more generalized destinations. As another example, a map can be provided in response to a web search query that implicitly calls for geographic results, such as when the search may be satisfied by a plurality of points of interest respectively having physical locations. Generally, the computing device can communicate with a server over a network in order to obtain the appropriate geographic information to provide to the user.

Furthermore, once a destination has been determined, a navigation system can automatically calculate a route and provide instructions to the determined destination. However, there are instances where a user may desire to customize how the instructions are presented while navigating to the destination based on knowledge of the surroundings, specific conditions, and user preferences.

Current navigation systems will typically provide a defined set of instructions to a user for navigating a route to a destination. The defined set of instructions will use a defined level of detail. For example, each user traveling on a given road to a specific destination might receive a warning that a left hand turn is coming up in 200 meters, followed by another instruction when the time to make the turn arrives. Current solutions do not allow for users to customize the level of detail or set other conditions associated with instructions for navigating to destinations.

### SUMMARY

Aspects and advantages of embodiments of the present disclosure will be set forth in part in the following description, or can be learned from the description, or can be learned through practice of the embodiments.

In one embodiment, a method for providing navigation instructions to a user can be provided. The method can include determining, by a computing system, a route from a current location of the user to a destination, the route including one or more route segments, each route segment of the one or more route segments having one or more associated instructions for the user. Th method can also include receiving, by the computing system, data indicative of a user request to modify the one or more instructions associated with at least one route segment of the one or more route segments. The method can further include determining, by the computing system, one or more modifications for the one or more instructions based on the received data indicative of the user request; modifying, by the computing system, the one or more instructions based on the determined one or more modifications; and storing, by the computing system, the one or more modified instructions for output to the user.

In another embodiment, a system for providing navigation instructions to a user can be provided. The system can include one or more processors and a non-transitory, computer-readable medium. The non-transitory, computer-readable medium can include instructions that, when executed by the one or more processors, cause the one or more processors to perform a process. The process can include determining a route from a current location of the user to a destination, the route including one or more route segments, each route segment of the one or more route segments having one or more associated instructions for the user. The process can also include receiving data indicative of a user request to modify the one or more instructions associated with at least one route segment of the one or more route segments. The process can further include determining one or more modifications for the one or more instructions based on the received data indicative of the user request; modifying the one or more instructions based on the determined one or more modifications; and storing the one or more modified instructions for output to the user

In a further embodiment, a non-transitory, computer-readable medium can include instructions that, when executed by one or more processors, cause the one or more processors to perform a process. The process can include determining a route from a current location of a user to a destination, the route including one or more route segments, each route segment of the one or more route segments having one or more associated instructions for the user. The process can also include receiving data indicative of a user request to customize the one or more instructions associated with at least one route segment of the one or more route segments. The process can further include determining one or more modifications for the one or more instructions based on the received data indicative of the user request; modifying the one or more instructions based on the determined one or more modifications; and storing the one or more modified instructions for output to the user.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

A full and enabling description of the present disclosure, directed to one of ordinary skill in the art, is set forth in the specification, which makes reference to the appended figures, in which:

FIG. 1 depicts a block diagram of example computing systems according to example embodiments of the present disclosure.

FIG. 2 depicts a flow chart of an example method for providing customized navigation instructions to a user according to example embodiments of the present disclosure.

FIG. 3 depicts an example user interface for a navigation session software module according to example embodiments of the present disclosure.

FIG. 4 depicts an example user interface for a navigation session according to example embodiments of the present disclosure.

### DETAILED DESCRIPTION

### Overview

Generally, the present disclosure is directed to a computerized mapping system that can recommend paths for navigational routing to a user.

The systems and methods according to the present disclosure allow users to customize how and when instructions are received during navigation to the destination by receiving user commands, such as voice commands or other user input, and then modifying presentation of instructions or modifying the instructions themselves based on the received user command. For example, the user can request to have more detailed instructions provided for the whole navigated route or a segment of the navigated route. In response, the system can interpret the request and, for future instructions in the current route or future routes, provide additional navigation details, such as providing indications to make a turn at 200 meters, 100 meters, 50 meters, and at the point of the turn, instead of only providing an indication to turn at 200 meters and at the point of the turn. In another example, the user can request to disable navigation instructions until the destination of the current route is reached, such as when a user is navigating home and reaches a familiar navigation area (e.g., when the user enters a known neighborhood, when a user reaches a freeway exit near to the home of the user, and the like). In a further example, the user can request that instructions be provided at a louder volume within the confines of a city or other noisy environment, such as on busy freeways or areas where traffic data indicates that more vehicles or other noise sources are nearby, which may inhibit the ability of the user to hear instructions at a normal or standard volume.

The systems and methods according to the present disclosure can use existing mapping and routing software to determine a route from a current position of the user to a destination requested by the user. While the navigation session is ongoing (e.g., the user is driving to the destination by taking the determined route), the user can choose to issue requests to customize navigation instructions for the route. In some embodiments, because the user is the one navigating and cannot divert attention away from operating a vehicle, the user issues these requests using voice commands. To initiate these requests, users can use phrases such as using “hotwords” (pre-defined words or phrases for initiating requests), which signals to the system that the user will be making a modification request. In other embodiments (e.g., if a passenger is riding with the user or the vehicle is an autonomous or semi-autonomous vehicle that permits the user to divert attention away from operation of the vehicle), requests can be input by actuation mechanism (e.g., a button) or a user interface on a display.

After the request is initiated, the user inputs their request (e.g., speaks the request), which can be a natural language phrase for customizing subsequent navigation instructions. The request can also include optional start and end conditions. For example, the user can speak “Can you provide me with more detail when we're driving through the city?” This request indicates that the user wants more details for instructions, such as additional instructions about upcoming turns, while located within city boundaries (an optional start/end condition). In another example, the user can speak “I know how to get home from here,” which disables all navigation instructions for the current route until the user reaches home, the destination.

To parse the user's request, natural language processing techniques can be used, such as using known grammars/syntaxes and/or using machine learning models. The user's request can be transcribed and used as input to the grammars/syntaxes and/or machine learning models, with an output being user intents and associated slot values. For example, an input of “can you give me more detail while we're in the city” can have an output of {INCREASE_DETAIL, condition: “in city”}, where the intent is to increase the level of navigation detail given to the user and the slot values include conditions such as “only in the city.”

Based on the output, the presentation of instructions for the current route being navigated by the user can be modified. In some embodiments, the requested modifications can also be saved as settings for later modification (e.g., a “sticky configuration”). For example, the user may wish to make certain modifications permanent, such as always receiving an increased level of navigation instructions while in a particular city. The user can request this modification and an associated setting can be saved in a memory. For future requested routes in the city, the user can be provided additional levels of navigation detail.

The proposed systems and methods enable users to receive desired levels of detail when navigating routes. This allows the user to customize what instructions they are hearing, what conditions can change what instructions are being presented, when instructions are being presented, and how instructions are being presented. By enabling users to have custom levels of direction details, unique user needs during navigation can be catered to, and special navigation situations (e.g., navigating in a new city) can have rules that define extra levels of detail so that the user can accurately navigate to destinations regardless of familiarity with the driving environment and driving situation. This dynamic level of instructions and ability to receive custom instructions in real-time from the user enables the system to efficiently navigate users to proper destinations.

The proposed systems and methods improve computer technology by enabling users to define a custom level of navigation instructions. In some instances, the user can request that particular instructions only be given under certain conditions, which can save processing cycles for the system by requiring instructions to be presented on a limited basis. In other instances, because modification settings for navigation instructions can be saved for future use, the system can save processing cycles, network bandwidth, and/or memory space by restricting the types of instructions being presented to the user in certain driving situations going forward.

With reference now to the Figures, example embodiments of the present disclosure will be discussed in further detail.

### Example Devices and Systems

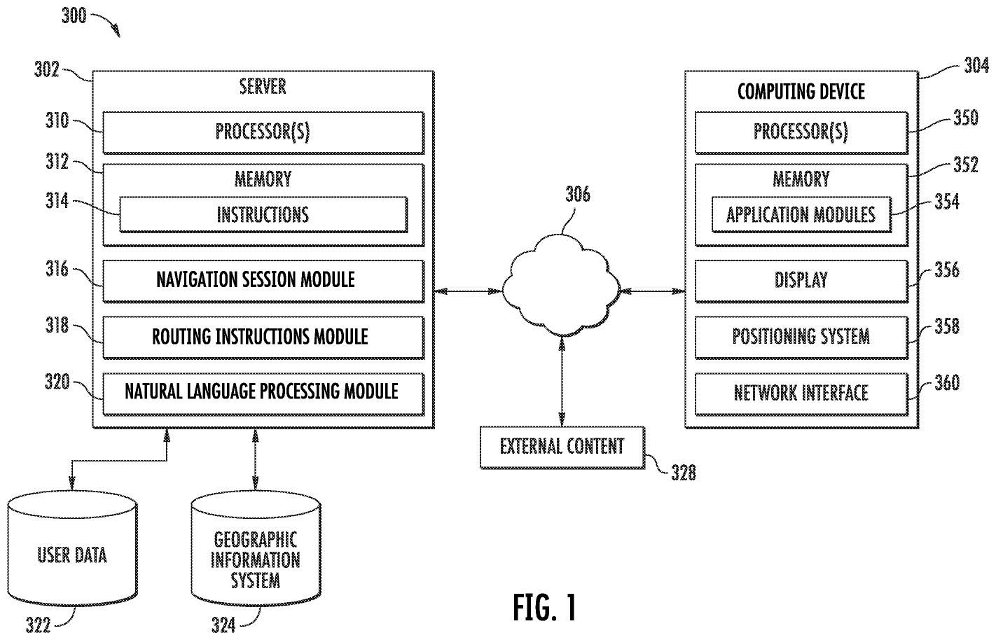

FIG. 1 depicts an example system 300 according to an example embodiment of the present disclosure. System 300 can include a client-server architecture, where a server 302 communicates with one or more computing devices 304 over a network 306. Although one computing device 304 is illustrated in FIG. 1, any number of computing devices can be connected to server 302 over network 306.

Computing device 304 can be, for example, a computing device having a processor 350 and a memory 352, such as a wireless mobile device, a personal digital assistant (PDA), smartphone, tablet, navigation system located in a vehicle, handheld GPS system, laptop computer, desktop computer, computing-enabled watch, computing-enabled eyeglasses, gaming console, embedded computing system, or other such devices/systems. In short, computing device 304 can be any computer, device, or system that can interact with the server system 302 (sending and receiving data) to implement the present disclosure.

Processor 350 of computing device 304 can be any suitable processing device and can be one processor or a plurality of processors that are operably connected. Memory 352 can include any number of computer-readable instructions or other stored data. In particular, memory 352 can include, store, or provide one or more application modules 354. When implemented by processor 350, application modules 354 can respectively cause or instruct processor 350 to perform operations consistent with the present disclosure, such as, for example, running a mapping application or a browser application in order to obtain and display personalized maps. Other modules can include a virtual wallet application module, a web-based email module, a game application module, or other suitable application modules.

It will be appreciated that the term “module” refers to computer logic utilized to provide desired functionality. Thus, a module can be implemented in hardware, firmware and/or software controlling a general purpose processor. In one embodiment, the modules are program code files stored on the storage device, loaded into memory and executed by a processor or can be provided from computer program products, for example, computer executable instructions that are stored in a tangible computer-readable storage medium such as RAM hard disk or optical or magnetic media.

Computing device 304 can include a display 356. Display 356 can be any suitable component(s) for providing a visualization of information, including, for example, touch-sensitive displays (e.g. resistive or capacitive touchscreens), monitors, LCD screens, LED screens (e.g. AMOLED), or other display technologies.

Computing device 304 can further include a positioning system 358. Positioning system 358 can determine a current geographic location of computing device 304 and communicate such geographic location to server 302 over network 306. The positioning system 358 can be any device or circuitry for analyzing the position of the computing device 304. For example, the positioning system 358 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

In the instance in which the user consents to the use of positional or location data, the positioning system 358 can analyze the position of the computing device 304 as the user moves around in the world and provides the current location of computing device 304 to the server 302 over network 306. The current location of computing device 304 can be displayed on the map and can influence aspects of the present disclosure, including scores assigned to point of interest search results.

Computing device 304 can further include a network interface 360. Network interface 360 can include any suitable components for interfacing with one more networks, including for example, transmitters, receivers, ports, controllers, antennas, or other suitable components.

Server 302 can be implemented using one or more suitable computing devices and can include a processor 310 and a memory 312. For example, server 302 can be one server computing device or can be a plurality of server computing devices that are operatively connected. In the instance that server 302 includes a plurality of server computing devices, such plurality of server computing devices can be organized into any suitable computing architecture, including parallel computing architectures, sequential computing architectures, or some combination thereof.

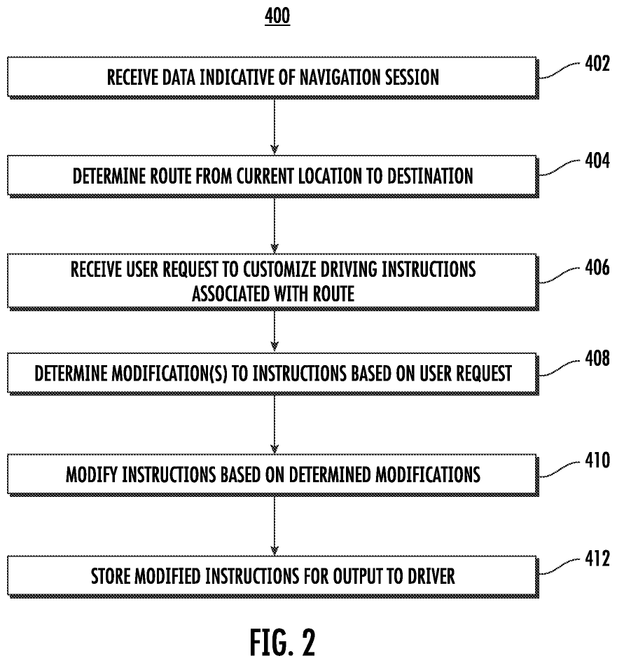

Processor 310 can be any suitable processing device and can be one processor or a plurality of processors which are operably connected. Memory 312 can store instructions 314 that cause processor 310 to perform operations to implement the present disclosure, including performing aspects of method (400) of FIG. 2.

Server 302 can include one or more modules for providing desired functionality. For example, server 302 can include a navigation session module 316, a routing instructions module 318, and a natural language processing module 320. Other modules to perform additional functionality can be included as well.

Server 302 can implement navigation session module 316 to assist in navigation using GPS data. For example, navigation session module 316 can receive GPS data associated with a current location of a user associated with the user and can receive GPS data associated with one or more other locations, such as a destination for a current navigation session. A navigation session can be a period in which the user navigates to a desired destination or set of destinations in a sequence. The navigation session module 316 can then determine one or more routes between the current location of the user and the desired destination. Routes can be determined based on various factors, such as shortest driving distance, shortest driving time, specific routes to pass by certain landmarks or to stop at intermediate destinations between the current location and the desired destination, and the like. Each of the determined routes can have one or more route segments, which represent portions of the route divided based on maneuvers to transition in between each of the portions. For example, a route segment may be defined as driving in a straight line along a road for a predetermined distance and then executing a maneuver, such as a right turn or a merge onto a highway. After the maneuver is performed, a new route segment is followed. In some embodiments, route segments can include more than one portion of a route and can include more than one maneuver. For example, the route segment can include a merge onto a first ramp for an interstate interchange and an immediate merge onto a second ramp. After the user executes the second merge onto the second ramp, a new route segment following the new road can be started. The navigation session module 316 can communicate with the routing instructions module 318 and receive instructions for navigating the various route segments in a route.

Server 302 can implement routing instructions module 318 to provide driving instructions to a user for various route segments in a route. For example, a route segment can include driving along a road for a predetermined period of time and then executing a maneuver to transition to a new route segment, such as taking a right turn. The driving instructions for this route can include statements such as “continue along Highway 1 for 50 miles” for following a route, and driving instructions for maneuvers can include “turn right onto Main Street in 250 feet.” Driving instructions can include various levels of details and conditions. For example, a driving instruction for a right turn maneuver can include “turn right onto Main Street in 250 feet” or can be more or less detailed, such as “stay in the right lane to turn right onto Main Street at the next stop sign in 250 feet” or “turn right at the next stop sign.” These navigation instructions can be presented as text or as audio to the user while the user is navigating during the navigation session.

The user can customize the instructions received during navigation sessions. For example, a user can request that additional levels of detail be given for driving instructions when the user is driving in an environment unknown or not well known to the user, such as driving in a new city, new state, or new country. In another example, a user can request that no more instructions be provided for the current route if the instructions are distracting the user or if the user is familiar with the driving environment (e.g., a neighborhood the user lives in, a town the user lives in, and the like). In a further example, a user may issue a condition-based modification to instructions, such as providing more or less detail for instructions based on if a user is within city limits, if weather conditions meet certain criteria, if traffic conditions meet certain criteria, and the like.

The user can also make modifications to various instruction settings stored in a memory associated with the user or a computing device associated with the user, such as a memory of a personal computing device associated with the user or a memory of an on-board computing system, such as system 300, of a vehicle. The instruction settings can be used to set “sticky configurations,” or modifications for instructions that persist over every future navigation session until the user changes the instruction setting. For example, a user can request that more detailed instructions be given while driving in a city (determined based on GPS coordinates of the current location of the user being compared to GPS data associated with the city). In some embodiments, this request can be stored as an instruction setting in the memory. In later navigation sessions, the user will not be required to provide this request for modification of instructions while in a city; instead, the instruction setting can be accessed and modifications to the instruction (e.g., more detail while in city limits) can be automatically performed. In some embodiments, the system 300 can prompt the user to confirm that the instruction setting should be stored. For example, the system 300 can output audio data that recites “Would you like to save this preference?” or another, similar phrase. The user can then provide a confirmation or denial to the system 300 that the instruction setting should be saved for future use.

Server 302 can implement a natural language processing (“NLP”) module 320 to process voice commands from the user into desired instructions and modifications to the instructions. The NLP module 320 can include a speech transcription module, which receives voice commands as audio data and outputs a transcription of the voice command, such as a word, a phrase, a sentence, or a series of sentences. To accomplish the transcription, one or more models for transcribing audio data can be used, such as speech recognition models, speech segmentation modules, and the like. The one or more models for transcribing audio data can receive the audio data and perform speech segmentation and speech recognition to identify what the user is saying in the received voice command. After identifying what is said in the voice command, a transcription (a textual representation of the speech of the voice command) can be generated. Based on the transcription, the NLP module 320 can use NLP to identify the semantic meaning of the voice command. NLP can include morphological analysis, syntactic analysis, lexical semantic analysis, relational semantic analysis, and the like. In some embodiments, the NLP module 320 can use one or more NLP machine learning-trained models to perform NLP, such as a recurrent neural network. In some embodiments, the machine learning model is trained using supervised learning to identify the intents and conditions in the received voice command.

For example, based on the transcription, the NLP module 320 can identify one or more intents of the voice command and conditions associated with each intent. An intent can be a desired modification to a driving instruction identified using NLP. For example, an intent can be “reduce detail,” “increase detail,” “cancel remaining instructions,” “provide additional instructions,” “provide less instructions,” and the like. In general, the intent represents what the user is requesting with the voice command.

Each intent can have one or more conditions associated with the intent. For example, the user can request that more details for each instruction be provided while in city limits, making “within city limits” the condition associated with the intent of “additional instruction details.” Therefore, additional instruction details will only be provided when driving instructions are issued when GPS location data associated with the user indicates the user is within city limits of a city.

In some embodiments, the NLP module 320 generates a set of intents for each instruction and stores each intent as a separate data object in a data structure. Each intent can have the conditions associated with that particular intent stored as slot values, or data field values within the particular intent data object.

Server 302 can be coupled to or in communication with one or more databases, including a database providing user data 322, a geographic information system 324, a database containing reviews 326, and external content 328. Although databases 322, 324, 326, and 328 are depicted in FIG. 1 as external to server 302, one or more of such databases can be included in memory 312 of server 302. Further, databases 322, 324, 326, and 328 can each correspond to a plurality of databases rather than a single data source.

User data 322 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. Generally, according to an aspect of the present disclosure, such data can be analyzed to determine when a user is traveling along a navigation route.

Importantly, the above provided examples of user data 322 are simply provided for the purposes of illustrating potential data that could be analyzed, in some embodiments, to identify when a user is traveling along a navigation route. However, such user data is not collected, used, or analyzed unless the user has consented after being informed of what data is collected and how such data is used. Further, in some embodiments, the user can be provided with a tool to revoke or modify the scope of permissions. In addition, certain information or data can be treated in one or more ways before it is stored or used, so that personally identifiable information is removed or stored in an encrypted fashion.

According to another aspect of the present disclosure, user data 322 can further store or provide one or more instruction settings. As described above with regards to the routing instructions module 318, user requests can be stored as an instruction setting in a memory. In later navigation sessions, the user will not be required to provide this request for modification of instructions while in a city; instead, the instruction setting can be accessed and modifications to the instruction (e.g., more detail while in city limits) can be automatically performed. In some embodiments, the system 300 can prompt the user to confirm that the instruction setting should be stored. For example, the system 300 can output audio data that recites “Would you like to save this preference?” or another, similar phrase. The user can then provide a confirmation or denial to the system 300 that the instruction setting should be saved for future use.

For example, each location update can identify the presently active user account and a unique device identifier that corresponds to the device providing the update. Each location update can further include a location (e.g. latitude and longitude) and a timestamp identifying the date and time of day. In some implementations, location updates can further include an accuracy indicator and/or other identifying information such as an originating IP address or a WiFi or cell tower identifier.

Geographic information system 324 can store or provide geospatial data to be used by server 302. Example geospatial data includes geographic imagery (e.g., digital maps, satellite images, aerial photographs, street-level photographs, synthetic models, etc.), tables, vector data (e.g. vector representations of roads, parcels, buildings, etc.), point of interest data, or other suitable geospatial data. Geographic information system 324 can be used by server 302 to provide navigational directions, perform point of interest searches, provide point of interest location or categorization data, determine distances, routes, or travel times between locations, or any other suitable use or task required or beneficial for performing the present disclosure.

Computer-based system 300 can further include external content 328. External content 328 can be any form of external content including news articles, webpages, video files, audio files, written descriptions, ratings, game content, social media content, photographs, commercial offers, transportation method, weather conditions, or other suitable external content. Server system 302 and computing device 304 can access external content 328 over network 306. External content 328 can be searched by server 302 according to known searching methods and can be ranked according to relevance, popularity, or other suitable attributes, including location-specific filtering or promotion.

Network 306 can be any type of communications network, such as a local area network (e.g., intranet), wide area network (e.g., Internet), or some combination thereof and can include any number of wired or wireless links. In general, communication between the server 302 and a computing device 304 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). Preferably, however, computing device 304 can freely move throughout the world and communicate with server 302 is a wireless fashion.

### Example Methods

FIG. 2 depicts a flow chart of an example method 400 for providing customized navigation instructions to a user according to example embodiments of the present disclosure. In some implementations, the method 400 is performed in response to the user starting a vehicle, the user actuating a user input mechanism such as a button or touch screen, the user providing a voice command to initiate a navigation session and the like.

The method 400 can include receiving, at one or more processors, data indicative of a navigation session (block 402). The data indicative of the navigation session can include information regarding a destination for the navigation session. The user can specify the destination using a user interface on a display screen of a computing system (e.g., an on-board vehicle computer, a software application on a mobile device, and the like). For example, the user can select on a display screen an option for initiating navigation to an input destination, can select a destination from a displayed map, can select a destination from a user-defined list of favorite destinations, can select a destination based on potential points of interest in the geographic area of the user, and the like.

In another embodiment, the user can actuate a user actuation mechanism, such as a button, switch, lever, knob, and the like. In response to the actuation, the system 300 can determine that the user is initiating a navigation session. The system 300 can provide an audio indication or visual indication that the navigation session is being initiated, and can optionally prompt the user to provide (via a user interface or voice command) a destination for the navigation session.

In yet another embodiment, because the user is operating a vehicle, the user can provide a voice command as the data indicative of a navigation session. In some embodiments, the user can speak one or more known “hotwords,” or pre-defined custom phrases. For example, the user may speak “Hey Maps,” “Initiate navigation,” “Begin routing to (destination),” “navigate me to (destination),” or other similar custom phrases. In some embodiments, the user can set a personalized custom phrase, which can be saved in memory and used to determine if the user is initiating a navigation session. In response to receiving the hotword from the user (via an internal microphone of a vehicle, via an internal microphone of a personal computing device associated with the user, and the like), the system 300 can initiate a navigation session. In some embodiments, the user can say the hotword, and the system can respond with a question-and-answer style response to indicate that the system is awaiting user input for instruction modification. For example, the user can speak “Hey Maps” and, in response, the system can respond with an audio response such as “how can I help you?” or “what would you like to do?” After this response, the user can speak input for modifying navigation instructions as described below.

In some implementations, the data indicative of the navigation session can also include additional navigation data, such as desired routes to the destination, desired route segments to include in the route, desired route conditions for planning the route, and the like. For example, a desired route and/or desired route segments can include routes or route segments that the user has driven before, routes or route segments that pass by certain landmarks or other intermediate destinations (e.g., navigating to home from current location but also passing a grocery store on the way to stop and pick up items), and the like. In another example, desired route conditions can include conditions such as routes or route segments with the least traffic, the fastest route or route segments, routes or route segments to take that do not enter city limits, and the like.

The method 400 can include determining, with the one or more processors, the route from the current location to the destination (at block 404). The route can include one or more route segments, or portions of the route. Route segments can be portions of the route that are separated by various maneuvers or other delineators. For example, one route segment can be driving straight along a roadway for a predetermined distance and making a maneuver (e.g., a right or left turn, a merge into a new lane, a stop at a stop sign or light, taking an entrance or exit ramp, and the like). After the maneuver is performed by the user, a new route segment can begin. In some embodiments, multiple maneuvers can be included in a route segment.

In some implementations, each route segment of the one or more route segments having one or more associated instructions for the user. For example, an instruction can direct the user to perform one or more driving maneuvers, continue on a current route segment, instruct the drive regarding changing traffic laws, and provide other information to aid the user in navigating to the destination of the navigation session. In one embodiment, an instruction can be “turn right on Main Street in 250 meters.” In another embodiment, an instruction can be “continue on Interstate 1 for 50 miles.” In yet another embodiment, an instruction can be “the speed limit is now 70 miles per hour.”

Instructions can have different levels of details. For example, an instruction can inform the user to “turn right on Main Street in 250 meters.” The same instruction can also be provided as “stay in the right lane on Cherry Street to turn right onto Main Street in 250 meters, at the next stop sign.” Each instruction can include the same base instruction (e.g., “turn right onto Main Street”) with different additional details that can be provided to the user based on a desired level of instruction detail. The desired level of instruction detail can be an instruction setting that is set by the user before navigating or that can be changed dynamically in response to the user requesting a change, such as described herein with regards to various aspects of the present disclosure.

The method 400 can also include receiving, at the one or more processors, data indicative of a user request to customize the one or more instructions associated with at least one route segment of the one or more route segments (at block 406). In some embodiments, the data indicative of the user request to customize the one or more instructions can include an indication that modifications for driving instructions are incoming, such as receiving an actuation of a user input mechanism (e.g., a button or switch). For example, the user can actuate a button, which indicates to the system 300 that modifications for driving instructions will be presented via voice commands by the user to the system. In other embodiments, the indication to the system 300 can be a specific voice command, such as a hotword like “Customize Navigation.” In further embodiments, no indication is required, and the user can input modifications for driving instructions directly via a voice command and/or an input to a user interface.

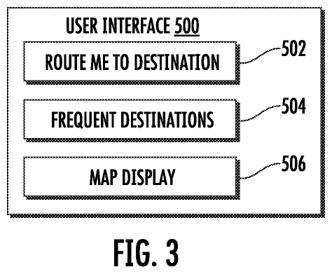

The modifications to the driving instructions can include one or more user inputs from a user interface. For example, a user can select an option from a plurality of displayed options on the user interface to choose various modifications for driving instructions from a pre-defined list of available modifications, such as increasing a level of detail for instructions provided to the user, canceling the providing of remaining instructions for a navigation session, having a specific level of detail of instructions provided based on geographic location of the user, and the like. Additional details regarding embodiments of exemplary user interfaces can be found below in relation to FIG. 3.

The modifications to the driving instructions can include one or more voice commands from the user. In some embodiments, the system 300 can receive voice commands as audio data (for example, from an on-board microphone of a vehicle) and perform processing on the audio data. For example, the one or more processors can parse the audio data of the voice command using NLP to generate a transcription of the voice command (e.g., a set of words, phrases, sentences, and other grammatical structures) as described above in relation to the NLP module 320.

The generated transcript can then be put into a machine learning model, such as an NLP model as described above in relation to the NLP module 320. The machine learning model processes the transcript to determine one or more intents of the received voice command, such as “provide more detailed instructions,” and optionally one or more conditions associated with each intent of the one or more intents as described above in relation to the NLP module 320. In some embodiments, each intent and its associated conditions can be saved as individual data objects in a data structure, with each condition being a slot value associated with its respective intent data object.

The method 400 can also include determining, with the one or more processors, one or more modifications for the one or more instructions based on the received data indicative of the user request (at block 408). In some or more embodiments, determining the one or more modifications for the one or more instructions is performed based on a plurality of intents and associated slot values generated from the transcript. For example, a generated plurality of intents can include an intent of “cancel remaining instructions for every remaining route segment in the route.” In response, the system 300 can modify instructions associated with remaining route segments in the route to not present any further instructions to the user until a new navigation session is initiated.

In another example, the generated plurality of intents can include an intent of “provide more instructions” and an associated condition slot value of “at night.” When the system 300 determines that the user is driving at night, the system 300 performs the modifications to instructions associated with route segments of the route to provide additional instructions to the user, such as modifying instructions to add additional instructions for maneuvers. For example, if a maneuver includes an instruction “turn right onto Main Street in 250 meters,” system 300 can add additional instructions to the maneuver, such as adding instructions “turn right onto Main Street in 100 meters” and “turn right onto Main Street now.”

In some embodiments, system 300 only modifies the one or more instructions in response to a condition of an associated slot value of an intent of the plurality of intents being met, such as only modifying instructions if the condition “at night” is met, the condition “is driving in city limits” is met, and the like.

In some embodiments, the one or more modifications can include increasing a level of navigation detail for at least one route segment of the one or more route segments (e.g., modifying “in 250 meters, turn right” to “Stay in the right lane and, in 250 meters, turn right onto Main Street at the next stop sign”), decreasing a level of navigation detail for at least one route segment of the one or more route segments (e.g., modifying “Stay in the right lane and, in 250 meters, turn right onto Main Street at the next stop sign” to “in 250 meters, turn right”), canceling remaining instructions associated with one or more route segments of the route between a current location of the user and the destination, adjusting a timing of presentation of an instruction associated with a route segment of the one or more route segments (e.g., modifying “in 250 meters, turn right” to “in 500 meters, turn right” and thus presenting a turning instruction earlier to the user), adjusting an output property of an instruction associated with a route segment of the one or more route segments (e.g., modifying an instruction to be presented at a higher or lower volume or selecting a driving instruction to be displayed on a user interface instead of being presented as audio data), and adjusting a specific detail of an instruction associated with a route segment of the one or more route segments (e.g., modifying “in 250 meters, turn right” to “in 1000 feet, turn right” or modifying “in 250 meters, turn right on Highway 1” to “in 250 meters, turn right onto Highway 1/Main Street”).

The method 400 can also include modifying, with the one or more processors, the one or more instructions based on the determined one or more modifications (at block 410). The determined modifications are made to the instructions associated with the route segment(s) by the system 300.

The method 400 can also include storing, with the one or more processors, the one or more modified instructions for output to the user (at block 412). The system 300 stores the modified instructions in a memory, such as a memory storing the route and associated route segments. When the user navigates onto a route segment with modified instructions, the modified instructions are then presented to the user at appropriate times, such as presenting an instruction to merge onto a highway when the user approaches the merge point of the highway, such as an on-ramp.

### Example User Experience

FIG. 3 depicts an example user interface 500 for a navigation session software module, such as navigation session software module 316, according to example embodiments of the present disclosure. User interface 500 can be presented to a user when the user starts a vehicle or is otherwise operating the vehicle. In some embodiments, user interface 500 can be displayed on a touch screen computing device, and the user can select various elements displayed on the user interface 500.

In some embodiments, user interface 500 can include a route element 502, a frequent destinations element 504, and a map display element 506. In other embodiments, the user interface 500 can include more or less and/or different elements than illustrated in FIG. 3.

When a user selects the route element 502, the user interface 500 can present a second user interface to the user to allow a user to input a desired destination for a navigation session. In another embodiment, in response to the user selecting the route element 502, system 300 can provide audio data requesting the user to speak a desired destination and can await a response from the user for the desired destination.

When the user selects the frequent destinations element 504, the user interface 500 can display a second user interface that shows frequent destinations of the user, such as “Home,” “Work,” “Mom's House,” “The Stadium,” and other destinations that the user may visit frequently. In some embodiments, the system 300 can learn over time what destinations the user repeatedly selects as a desired destination for a navigation session. For example, system 300 can track every destination selected as a desired destination by the user and display a list of the 5 most frequently selected destinations.

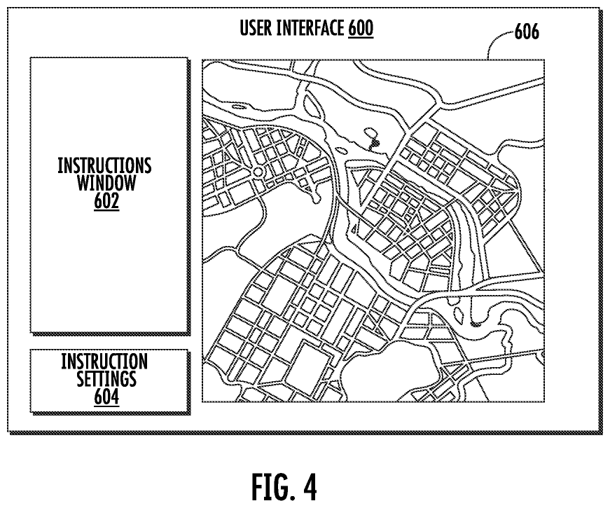

When the user selects the map display element 506, user interface 500 can display a map of an area surrounding the user, including details about the current route, route segments, and/or instructions. Additional details can be found below in relation to FIG. 4.

FIG. 4 depicts an example user interface 600 for a navigation session according to example embodiments of the present disclosure. In some embodiments, the user interface 600 can be displayed to the user during a navigation session. In other embodiments, the user interface 600 can be presented to the user in response to a selection of an element from a previous user interface, such as map display element 506 of FIG. 3.

In some embodiments, the user interface 600 can include an instructions window 602, an instruction settings element 604, and a displayed map 606. In other embodiments, the user interface 600 can include more or less and/or different elements than illustrated in FIG. 4.

The instructions window 602 can display a current route segment that the user is traveling along, one or more upcoming instructions for upcoming maneuvers and/or route segments, a total list of route segments and associated instructions, and the like. In some embodiments, the instructions window 602 can also be a selectable element of the user interface 600. When the instructions window 602 is selected, the user interface 600 can display a second user interface that can include a current route segment that the user is traveling along, one or more upcoming instructions for upcoming maneuvers and/or route segments, a total list of route segments and associated instructions, and the like. In some embodiments, when the instructions window 602 is selected, the user interface 600 can display a second user interface that the user can use to modify one or more instructions for the current route.

When the instruction settings element 604 is selected, the user interface 600 can display a second user interface that the user can interact with to modify one or more instruction settings as described above in relation to the route instructions module 318.

Displayed map 606 can display a map of the driving environment near the current location of the user, the current route and/or route segment the user is currently navigating, and optionally one or more other features, such as special visual indicators of landmarks, maneuvers, and the like. In some embodiments, the displayed map 606 can be a selectable element of the user interface 606. In some embodiments, when the displayed map 606 is selected by the user, a second user interface is presented with a larger scale displayed map that can be manipulated by the user (e.g., scroll, pan, zoom, and the like). In other embodiments, when the displayed map 606 is selected, various properties of the route/route segment/instructions can be displayed on a second user interface.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A method for providing navigation instructions to a user, the method comprising:
determining, by a computing system, a route from a current location of the user to a destination, the route including one or more route segments, each route segment of the one or more route segments having one or more associated instructions for the user;
receiving, by the computing system, data indicative of a user request to modify the one or more instructions associated with at least one route segment of the one or more route segments;
determining, by the computing system, one or more modifications for the one or more instructions based on the received data indicative of the user request;
modifying, by the computing system, the one or more instructions based on the determined one or more modifications; and
storing, by the computing system, the one or more modified instructions for output to the user.

2. The method of claim 1, further comprising providing, by the computing system, the one or more modified instructions as output to the user.

3. The method of claim 1, wherein the received data indicative of the user request includes a received user input from an interactive user interface or a user actuation mechanism.

4. The method of claim 1, wherein the received data indicative of the user request is a received voice command from the user.

5. The method of claim 4, wherein the received voice command is a custom phrase indicating that the user is making the user request.

6. The method of claim 4, further comprising:
parsing the voice command;
generating a transcribed voice command based on the parsed voice command;
inputting the transcribed voice command to a machine learning model;
processing the transcribed voice command using the machine learning model; and
outputting a plurality of intents and associated slot values, wherein each intent indicates a request made by the user and each associated slot value indicates a condition associated with the intent.

7. The method of claim 6, wherein determining the one or more modifications for the one or more instructions further includes determining one or more modifications for the one or more instructions based on the plurality of intents and associated slot values.

8. The method of claim 6, wherein modifying the one or more instructions includes performing the one or more modifications to the one or more instructions in response to a condition of an associated slot value of an intent of the plurality of intents being met.

9. The method of claim 6, wherein the machine learning model is a neural network and wherein the machine learning model is trained using supervised learning.

10. The method of claim 1, wherein the one or more modifications includes increasing a level of navigation detail for at least one route segment of the one or more route segments.

11. The method of claim 1, wherein the one or more modifications includes decreasing a level of navigation detail for at least one route segment of the one or more route segments.

12. The method of claim 1, wherein the one or more modifications includes cancelling remaining instructions associated with one or more route segments of the route between a current location of the user and the destination.

13. The method of claim 1, wherein the one or more modifications includes adjusting a timing of presentation of an instruction associated with a route segment of the one or more route segments.

14. The method of claim 1, wherein the one or more modifications includes adjusting an output property of an instruction associated with a route segment of the one or more route segments.

15. The method of claim 1, wherein the one or more modifications includes adjusting a specific detail of an instruction associated with a route segment of the one or more route segments.

16. The method of claim 1, wherein modifying the one or more instructions further comprises:
accessing one or more instruction settings associated with the user; and
modifying at least one instruction associated with a route segment of the one or more route segments based on the accessed one or more instruction settings.

17. The method of claim 16, wherein modifying the one or more instructions further comprises:
modifying at least one instruction setting of the one or more instruction settings; and
storing the modification of the at least one instruction setting to a memory of a computing device associated with the user.

18. The method of claim 17, further comprising:
receiving data indicative of a second navigation session, the data indicative of the second navigation session including data indicative of a second destination; and
determining a second route from the current location of the user to the second destination, the second route including one or more route segments, each route segment of the one or more route segments having one or more associated instructions for the user, wherein the one or more associated instructions include at least one modification based on the stored modification of the at least one instruction setting.

19. A system for providing navigation instructions to a user, the system comprising:
one or more processors; and
a non-transitory, computer-readable medium comprising instructions that, when executed by the one or more processors, cause the one or more processors to perform a process, the process comprising:
determining a route from a current location of the user to a destination, the route including one or more route segments, each route segment of the one or more route segments having one or more associated instructions for the user;
receiving data indicative of a user request to modify the one or more instructions associated with at least one route segment of the one or more route segments;
determining one or more modifications for the one or more instructions based on the received data indicative of the user request;
modifying the one or more instructions based on the determined one or more modifications; and
storing the one or more modified instructions for output to the user.

20. A non-transitory, computer-readable medium comprising instructions that, when executed by one or more processors, cause the one or more processors to perform a process, the process comprising:
determining a route from a current location of a user to a destination, the route including one or more route segments, each route segment of the one or more route segments having one or more associated instructions for the user;
receiving data indicative of a user request to customize the one or more instructions associated with at least one route segment of the one or more route segments;
determining one or more modifications for the one or more instructions based on the received data indicative of the user request;
modifying the one or more instructions based on the determined one or more modifications; and
storing the one or more modified instructions for output to the user.
